(19) United States
(12) Patent Application Publication
(10) Pub. No.: US 2002/0196761 A1
(43) Pub. Date: Dec. 26, 2002

(54) MAC address management method in wireless LAN, MAC address management program for wireless LAN, record medium recording MAC address management program for wireless LAN, fixed station for wireless LAN and wireless LAN system

(76) Inventor: Kiyohito Kaneko, Tokyo (JP)

Correspondence Address: ROSENTHAL & OSHA L.L.P., 1221 MCKINNEY AVENUE, SUITE 2800, HOUSTON, TX, 77010, US

(21) Appl. No.: 09/957,757

(22) Filed: Sep. 21, 2001

(30) Foreign Application Priority Data
Jun. 21, 2001 (JP) 2001-188045
Aug. 9, 2001 (JP) 2001-241717

(51) Int. Cl. H04Q 7/24

(52) U.S. Cl. 370/338; 709/209

(57) ABSTRACT

Fixed stations 1 to 3 are each constituted by including a wired LAN control section 13, a central control section 14, a wireless LAN control section 15, and a storage section 16. Each of the fixed stations 1 to 3 is actuated in order, and whether it is a master fixed station or a slave fixed station is determined by the central control section 14, and data of static MAC address tables are exchanged to each other between the master fixed station and the slave fixed stations with the master fixed station as a center, whereby all the fixed stations 1 to 3 have the static MAC address tables of the same content, thus achieving the sharing of MAC addresses.

### BACKGROUND OF THE INVENTION

1. Field of the Invention

The present invention relates to a wireless LAN (Local Area Network), and particularly related to the wireless LAN achieving increase in efficiency of MAC (Media Access Control) address management, and the like.

2. Description of the Related Art

As a result of improvement in performance of personal computers, reduction in their price and the like, networking of computers is facilitated even on a small scale as compared with the past, and so-called LANs are coming into widespread use in various companies and organizations.

Especially in recent years, as one mode of the above described LANs, a wireless LAN is becoming pervasive since it has the advantages of easiness for change after the construction of networks, being able to reduce the complicated operations and cost of laying cables as in a wired LAN, and the like.

FIG. 5 shows a configuration example of such a wireless LAN and a conventional wireless LAN will be explained below with reference to FIG. 5.

FIG. 5 shows the configuration example in which a plurality of fixed stations belonging to a same subnet are connected by a LAN trunk line, and slave stations connected via a wireless line are assigned to each of the fixed stations, and a basic configuration of such a wireless LAN is based on the International Standard IEEE802.11 defined by IEEE (Institute of Electrical and Electronics Engineers: The United States Institute of Electrical and Electronics Engineers).

Specifically, in FIG. 5, three fixed stations AP1 to AP3 generally called access points are connected to the LAN trunk line (represented by “LAN-BB” in FIG. 5), and they belong to the same subnet. As for connection to other LANs, a router and a bridge not shown are connected to the LAN trunk line, and data can be exchanged with different subnets via the router.

Meanwhile, mobile terminals are connectable to each of the fixed stations AP1 to AP3.

Specifically, in this configuration example, mobile terminals S1 and S2 are communicable with the fixed station AP1 via the wireless line, a mobile terminal S3 with the fixed station AP2, and mobile terminals S4 and S5 with the fixed station AP3, respectively. Each of the mobile terminals is usually constituted by a NIC (Network Interface Card) having a wireless transmission/reception function and a personal computer.

In the above configuration, on communication between the mobile terminals and the fixed stations, verification by a MAC address is performed.

For example, in the fixed station AP1, the MAC addresses of the mobile terminal S1 and the mobile terminal S2 are previously registered, and when a communication request is made by the mobile terminal S1 to the fixed station AP1, the fixed station AP1 judges whether or not the MAC address transmitted on the communication request of the mobile terminal S1 corresponds to the MAC address it possesses. If it corresponds to the address, the communication hereinafter is permitted, and processing of writing the MAC address of the mobile terminal S1 into a dynamic MAC address table is performed on the fixed station AP1. Ditto for the mobile terminal S2.

When no access is made to the fixed station AP1 from the mobile terminals S1 and S2 for more than a predetermined period of time, or when no response comes from the mobile terminals S1 and S2 to the access from the fixed station AP1 for more than a predetermined period of time, the MAC addresses corresponding to the mobile terminals are deleted from the aforementioned dynamic MAC address table, and effective use of memory is made especially when a number of mobile terminals are connected to one fixed station.

Meanwhile, the fixed stations AP1 to AP3 usually has a filtering function using the MAC addresses as described above, whereby security can be maintained.

Specifically, in the fixed stations AP1 to AP3, if the filtering function is set to be on, renewal of the dynamic MAC table as described above is not made, and MAC data of the mobile terminals previously set is fixed and held.

For example, assume that the MAC addresses of the mobile terminals S1 and S2 are 1 and 2 for convenience, the 1 and 2 are fixed and held in the MAC address table in the fixed s tation AP1.

Similarly, 3 as an MAC address of the mobile terminal S3 is fixed and held in the fixed station AP2, and 4 and 5 as MAC addresses of the mobile terminals S4 and S5 are fixed and held in the fixed station AP3, respectively. In FIG. 5, such a state of the MAC address table is schematically shown by shading each of the MAC address tables shown beside each of the fixed stations AP1 to AP3 with oblique lines.

Accordingly, even if a new mobile terminal moves to a service area of any of the fixed stations AP1 to AP3 from some other place, the fixed stations AP1 to AP3 do not accept communication with the new mobile terminal unless it is registered before the setting of the filtering function.

However, in the conventional configuration, security can be increased by effecting the filtering function of the fixed stations, but on the other hand, if the mobile terminal moves to a different service area, even in the same subnet, communication cannot be made, whereby it becomes necessary to register the MAC address of the mobile terminal, which moves thereto, to the new fixed station in order to be able to make communication in the new service area, which becomes the disadvantage that the system has a low degree of flexibility.

### SUMMARY OF THE INVENTION

An object of the present invention is to provide a MAC address management method in a wireless LAN, a MAC address management program for a wireless LAN, a record medium recording the MAC address management program for a wireless LAN, a fixed station for a wireless LAN and a wireless LAN system, which can make it easy to move mobile terminals in the same subnet while maintaining security in the same subnet.

Another object of the present invention is to provide a MAC address management method in a wireless LAN, a MAC address management program for a wireless LAN, a record medium recording the MAC address management program for a wireless LAN, and a fixed station for a wireless LAN, which can provide a wireless LAN system easy to use and extremely convenient.

In order to attain the above objects of the invention, according to a first aspect of the invention,

a MAC address management method for fixed stations in a wireless LAN system having the fixed stations connected to a LAN trunk line and mobile terminals for exchanging packets with the aforesaid fixed stations via a wireless line, comprising the steps of:

in the fixed stations actuated one by one in order,

judging whether or not any other actuated fixed stations exist in a same segment, after actuation, and when it is judged that any other actuated fixed stations don't exist, making its own station a master fixed station, while when it is judged that the other actuated fixed station exists, making its own station a slave fixed station; and

in the master fixed station, transmitting data of a static MAC address table of its own station to the slave fixed station when it is judged that the slave fixed station is newly actuated, and when receiving transmission of data of the static MAC address table after renewal as a result of the renewal of the static MAC address table in the slave fixed station from the slave fixed station, renewing the static MAC address table of its own station according to the received data of the static MAC address table, and transmitting data of the static MAC address table of its own station after the renewal to the slave fixed station other than the slave fixed station of which data transmission of the static MAC address table is received to thereby allow sharing of MAC addresses, is provided.

In the above method, the fixed stations in the same segment are divided into the master fixed station and the slave fixed stations according to the order of actuation of the fixed stations. When the renewal of the static MAC address table in the master fixed station is made, the content after the renewal is transmitted to all the slave fixed stations, and when the static MAC address table is renewed in any of the slave fixed stations, the content after the renewal is transmitted to the other slave fixed station via the master fixed station, thus realizing the sharing of the static MAC address tables in the master fixed station and the slave fixed stations, whereby registration content of a new MAC address occurring to any of the fixed stations is also registered to the other fixed stations in the same segment, and the degree of flexibility in the movement of the mobile terminals in the same segment can be increased.

Further, according to a second aspect of the present invention,

a MAC address management program for a wireless LAN for static MAC address management, which is executed by a central control section in a fixed station for a wireless LAN, comprising a wired LAN control section for controlling exchange of packets via a LAN trunk link, a wireless LAN control section for controlling exchange of packets with mobile terminals via a wireless line, a central control section for performing operation control of the aforesaid wired LAN control section and the aforesaid wireless LAN control section and performing the static MAC address management, and a storage section for storing program necessary for operation of the aforesaid wired LAN control section, wireless LAN control section and central control section and data, and having a packet relay function between a wired network and a wireless network,

wherein said central control section judges whether or not execution of the program is a first time, and when judging it as the first time, performs post actuation fixed station existence judgement processing, while when judging it as not the first time, judges whether or not its own station is a master fixed station; and

in the judgement of whether or not it is the master fixed station, when judging its own station is the master fixed station, the central control section performs slave fixed station addition judgment processing, and when judging its own station is not the master fixed station, it performs master fixed station MAC address table renewal presence or absence judgment processing, is provided.

Furthermore, according to a third aspect of the present invention,

a computer-readable record medium recording a MAC address management program for a wireless LAN, which is executed by a central control section in a fixed station for a wireless LAN, comprising a wired LAN control section for controlling exchange of packets via a LAN trunk link, a wireless LAN control section for controlling exchange of packets with mobile terminals via a wireless line, the central control section for performing operation control of the aforesaid wired LAN control section and the aforesaid wireless LAN control section and performing static MAC address management, and a storage section for storing program necessary for operation of the aforesaid wired LAN control section, wireless LAN control section and central control section and data, and having a packet relay function between a wired network and a wireless network,

wherein the aforesaid central control section judges whether or not execution of the program is a first time, when judging it as the first time, performs post actuation fixed station existence judgement processing, and when judging it as not the first time, judges whether or not its own station is a master fixed station; and

in the judgement of whether or not it is the master fixed station, when judging its own station is the master fixed station, the central control section performs slave fixed station addition judgment processing, and when judging its own station is not the master fixed station, it performs master fixed station MAC address table renewal presence or absence judgment processing, is provided.

Still further, according to a fourth aspect of the invention,

a fixed station for a wireless LAN, comprising:

a wired LAN control section for controlling exchange of packets via a LAN trunk link,

a wireless LAN control section for controlling exchange of packets with mobile terminals via a wireless line;

a central control section for performing operation control of the aforesaid wired LAN control section and aforesaid wireless LAN control section, and performing static MAC address management; and

a storage section for storing program necessary for operation of the aforesaid wired LAN control section, wireless LAN control section and central control section, and data

the fixed station having a packet relay function between a wired network and a wireless network,

wherein the aforesaid central control section judges whether or not any other actuated fixed stations exist in a same segment after being actuated, and when it is judged that any other actuated fixed stations don't exist, it makes its own station a master fixed station, while when it is judged that the other actuated fixed station exists, it makes its own station a slave fixed station,

wherein in the master fixed station, the central control section transmits data of a static MAC address table of its own station to the slave fixed station when it is judged that the slave fixed station is newly actuated, and when receiving transmission of data of the static MAC address table after renewal as a result of the renewal of the static MAC address table in the slave fixed station from the slave fixed station, it renews the static MAC address table of its own station according to the data of the static MAC address table of which transmission it receives, and transmits data of the static MAC address table of its own station after the renewal to the slave fixed station other than the slave fixed station of which transmission data of the static MAC address table it receives, is provided.

The above-described configuration is the configuration suitable for carrying out the MAC address management method for the fixed stations in the wireless LAN system according to the invention in claim 1, and especially the central control section can be realized by using, for example, a microcomputer, whereby the MAC address management method for the fixed stations in the wireless LAN system can be easily carried out.

Further, according to a fifth aspect of the invention,

a fixed station for a wireless LAN, comprising

a wired LAN control section for controlling packet exchange via a LAN trunk link,

a wireless LAN control section for controlling packet exchange with mobile terminals via a wireless line,

a central control section for performing operation control of the aforesaid wired LAN control section and the aforesaid wireless LAN control section and performing static MAC address management, and

a storage section for storing program necessary for operation of the aforesaid wired LAN control section, wireless LAN control section and central control section, and data

the fixed station having a packet relay function between a wired network and a wireless network,

wherein the static MAC address management by the aforesaid central control section is performed by execution of an MAC address management program for a wireless LAN by the aforesaid central control section, and the MAC address management program for the wireless LAN is structured so that

the aforesaid central control section judges whether or not execution of the program is a first time, and when judging it is the first time, performs post actuation fixed station existence judgement processing, while when judging it is not the first time, judges whether or not its own station is a master fixed station, and

in the judgement of whether or not it is the master fixed station, when judging its own station is the master fixed station, the central control section performs slave fixed station addition judgment processing, and when judging its own station is not the master fixed station, it performs master fixed station MAC address table renewal presence or absence judgment processing, is provided.

Furthermore, according to a sixth aspect of the invention,

a wireless LAN system with a plurality of fixed stations having a packet relay function between a wired network and a wireless network being connected to a LAN trunk line, having a plurality of mobile terminals previously registered to the aforesaid plurality of fixed stations and allowed to exchange packets with the fixed stations via a wireless line,

wherein the aforesaid fixed station is the fixed station for the wireless LAN according to any one of claim 21 through claim 32.

### BRIEF DESCRIPTION OF THE DRAWINGS

FIG. 1 is a block diagram showing a configuration example of a wireless LAN system in an embodiment of the present invention;

FIG. 2 is a block diagram showing a configuration example of a fixed station used in the wireless LAN system shown in FIG. 1;

FIG. 3 is a flowchart showing a procedure of a first half part of MAC address management processing for a wireless LAN executed in the fixed station used in the wireless LAN system shown in FIG. 1;

FIG. 4 is a flowchart showing a procedure of a latter half part of the MAC address management processing for a wireless LAN executed in the fixed station used in the wireless LAN system shown in FIG. 1; and

FIG. 5 is an explanatory view of a MAC address management method in a conventional wireless LAN.

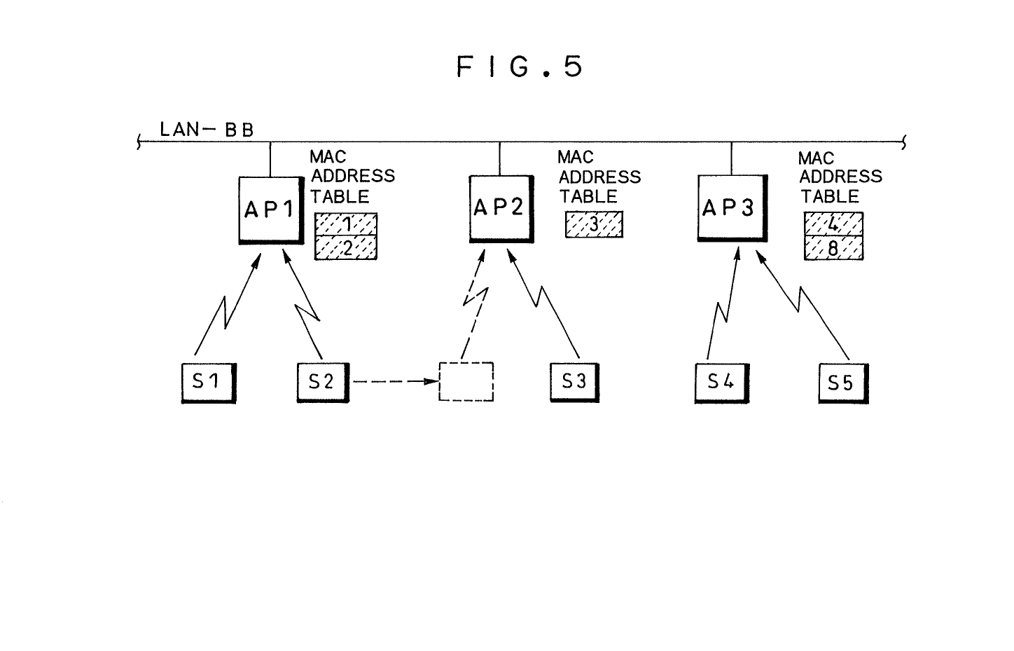

### DETAILED DESCRIPTION OF THE PREFERRED EMBODIMENTS

The preferred embodiments of the present invention will be explained in detail below with reference to the attached drawings.

It should be noted that the components, arrangement and the like which will be explained hereinafter are not intended to restrain the present invention, and various changes may be made therein within the spirit of the present invention.

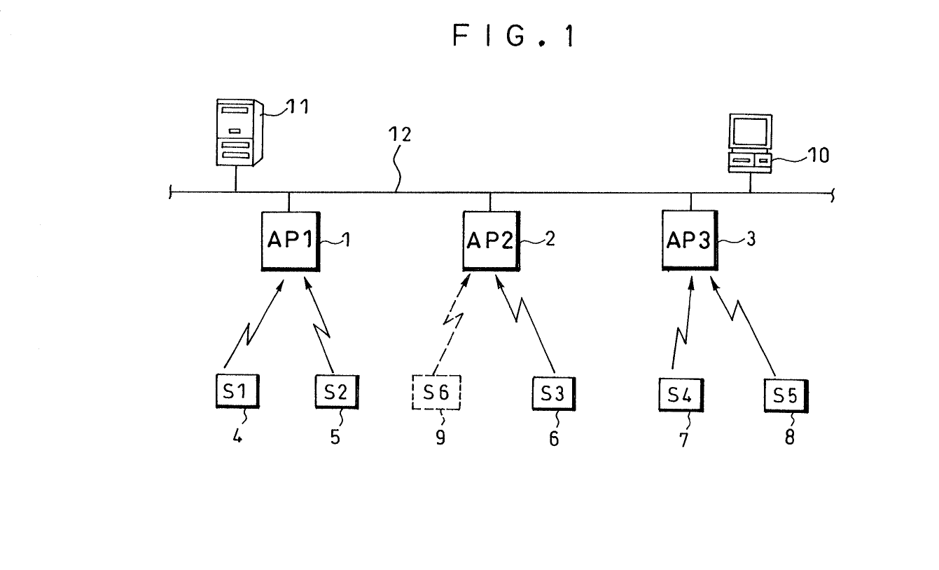

First, a configuration example of a wireless LAN system of the embodiment of the present invention will be explained with reference to FIG. 1.

The wireless LAN system is basically the same as the prior art in its hardware configuration, and it is constituted by including a plurality of fixed stations (represented by “AP1”, “AP2”, and “AP3” in FIG. 1) 1 to 3 generally referred to as access points and connected to a LAN trunk line 12, a plurality of mobile terminals (“S1”, “S2”, “S3”, “S4”, and “S5” in FIG. 1) 4 to 8, an administrative computer 10, and a server 11.

The fixed stations 1 to 3 are wire-connected to each other by the LAN trunk line 12, and packet exchange can be made with one another, while the fixed stations 1 to 3 can make communication with the respective corresponding mobile terminals 4 to 8 via a wireless line. The fixed stations 1 to 3 performs the function of transmitting packets from the LAN trunk line 12 to the corresponding mobile terminals while transmitting packets from the corresponding mobile terminals to the LAN trunk line 12, and the like, and they have a bridge relay function of performing packet exchange between the wired network of the LAN trunk line 12 side and the wireless network of the mobile terminals 4 to 8 side. It should be noted that the basic configurations and the like of the fixed stations 1 to 3 are based on the International Standards IEEE802.11 and IEEE802.11b defined by the IEEE (Institute of Electrical and Electronics Engineers: The United States Institute of Electrical and Electronics Engineers).

The fixed stations 1 to 3 in the embodiment of the present invention are the same as in the prior art in the basic operation except for the point that the MAC address management processing that will be described later is to be executed when they are actuated. In the embodiment of the present invention, these fixed stations 1 to 3 belong to the same subnet (in other words, the same segment). A mobile terminal 9 (represented by “S6” in FIG. 1) shown by the dotted line in FIG. 1 has moved here from a different subnet from the subnet the fixed stations 1 to 3 belong to, and it can exchange packet to and from the fixed stations 1 to 3 by being registered to any one of the fixed stations 1 to 3 as will be described later.

The mobile terminals 4 to 8 are each usually constituted by a NIC (Network Interface Card) having a wireless transmission and reception function and a personal computer.

A bridge and a router not shown are connected to the LAN trunk line 12 as necessary, whereby packet exchange can be made between the wireless LAN constituted by the fixed stations 1 to 3 and the mobile terminals 4 to 8, and other wired or wireless LANs (in other words, other segments or other subnets) not shown.

The administrative computer 10 is for monitoring an operating state of the LAN connected with the LAN trunk line 12, and the like.

The server 11 is for providing necessary information to the mobile terminals 4 to 8 being the clients via the fixed stations 1 to 3, and the like.

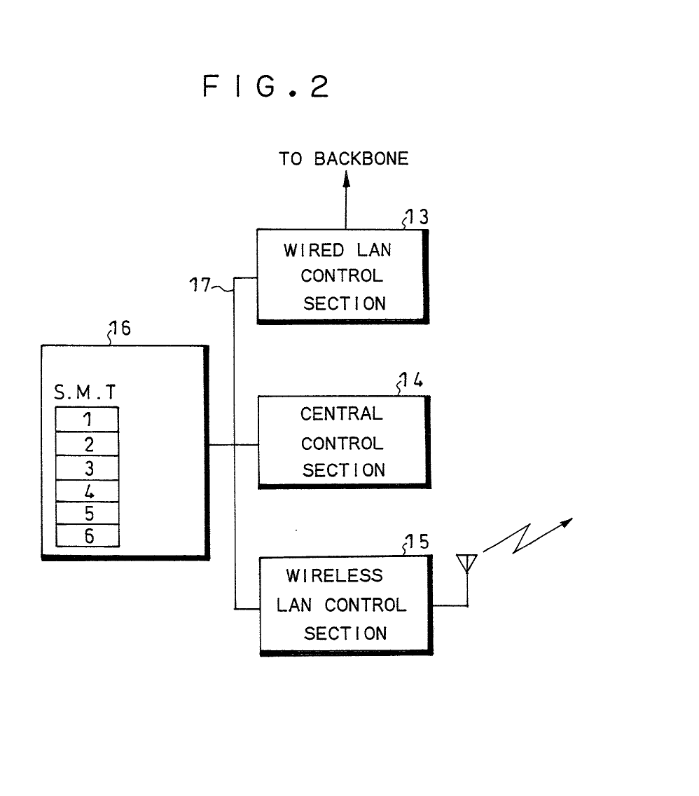

FIG. 2 shows a configuration example of each of the fixed stations 1 to 3, and the configuration of each of the fixed stations 1 to 3 will be explained with reference to FIG. 2. Since all of the fixed stations 1 to 3 have the same basic configurations, the explanation of FIG. 2 represents the configuration of each of the fixed stations 1 to 3.

First, the fixed stations 1 to 3 are each mainly constituted by a wired LAN control section 13, a central control section 14, a wireless LAN control section 15 and a storage section 16, and they are connected to each other via a common internal bus 17.

The wired LAN control section 13 is connected to the LAN trunk line (backbone) 12 and performs processing necessary for packet exchange with a physical layer and a data link layer of the wired LAN, and it has the function of transmitting the packets transmitted to the mobile terminals from the wired LAN side to the mobile terminals via the wireless LAN control section 15 which will be described later, while transmitting the packets from the mobile terminals to the LAN trunk line 12 via the wireless LAN control section 15, and the like.

The wireless LAN control section 15 has the wireless transmission and reception function to exchange packets with the mobile terminals, and performs control processing of a physical layer and data link layer in the wireless LAN.

The central control section 14 performs operation control of an entire apparatus, and MAC address management processing which will be describe later is executed by the central control section 14. The central control section 14 as described above can be realized, for example, by a microcomputer and a device having the equivalent function.

The storage section 16 stores the programs necessary for the operation of the wired LAN control section 13, the wireless LAN control section 15 and the central control section 14, and in addition to this, temporarily stores packet data and the like. It has the area in which the stored memory is erased by shutting off the power of the apparatus and the area in which the stored memory is not erased even if the power of the apparatus is shut off. Such a storage section 16 is preferably constituted by using, for example, a semiconductor memory such as ROM and RAM, a hard disc, or the like.

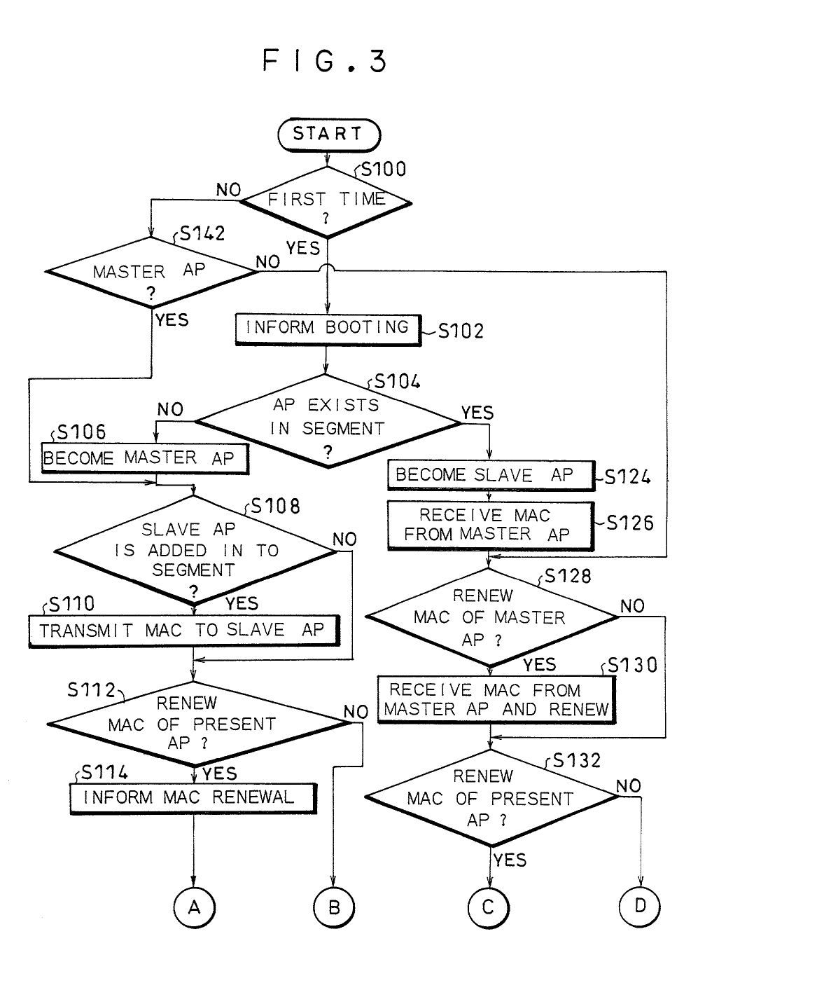

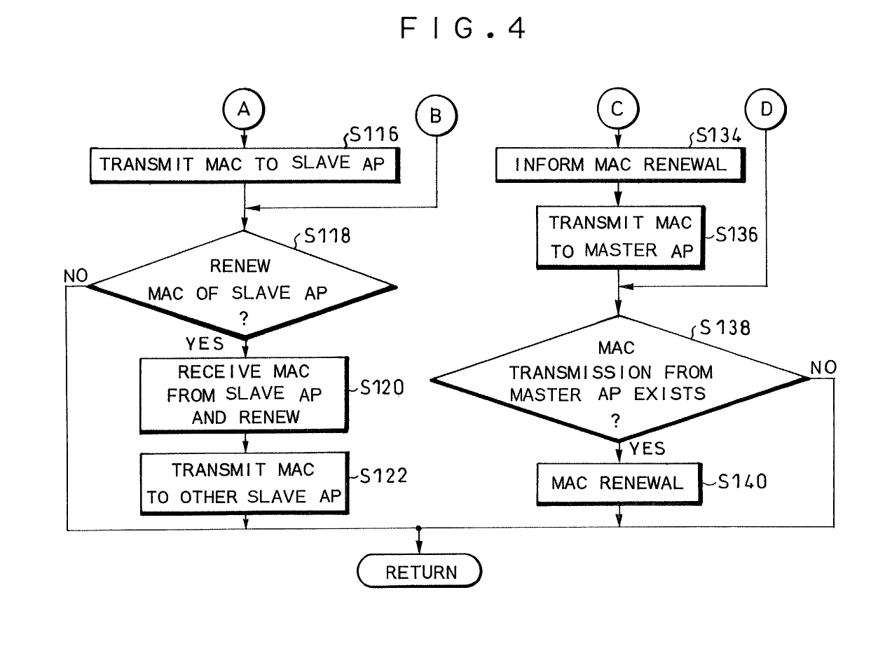

Next, the MAC address management process carried out in the fixed stations 1 to 3 will be explained with reference to FIG. 3 and FIG. 4.

First, explaining the outline of the MAC address management processing before explaining the details of it, the processing is carried out as a subroutine processing in the fixed stations 1 to 3 in the wireless LAN system as shown in FIG. 1.

Specifically, as a precondition, suppose that the fixed stations 1 to 3 are actuated in the order of the fixed station 1, the fixed station 2 and the fixed station 3 after they are connected to the LAN trunk line 12.

The MAC address management processing shown in FIG. 3 and FIG. 4 is carried out in the fixed stations 1 to 3 in the above order, whereby proper MAC address management can be realized. Since the fixed stations 1 to 3 belong to the same segment, the mobile terminals 4 to 8 are previously registered as communicable mobile terminals in all the fixed stations 1 to 3. Specifically, in other words, the MAC address of each of the mobile terminals 4 to 8 is registered in a table stored especially in a writable and readable, and nonvolatile storage area of the storage section 16 of the fixed stations 1 to 3.

Here, as for the MAC address tables of the fixed stations 1 to 3, there are the dynamic MAC address tables in which when response is not transmitted from any of the mobile terminals 4 to 8 in a fixed period of time, the MAC address of the corresponding mobile terminal is erased from the table, and a static MAC address table in which such erasure is not made at each fixed time, and it is the static MAC address table (represented by “S. M. T” in FIG. 2) that is used for the previous registration of the mobile terminal as described above.

Explaining in concrete below, when a power switch not shown of the fixed station 1 is turned on, main routine processing not shown is started by the central control section 14, then the execution of the MAC address management processing as a subroutine processing shown in FIG. 3 and FIG. 4 is started via the main routine processing, and it is initially judged whether or not this processing is the first processing after the actuation of the fixed station 1 (refer to step S100 in FIG. 3).

In step S100, when it is judged as the first time (in the case of YES), the processing proceeds to step S102 which will be described later, and when it is judged that this is not the first time (in the case of NO), the processing proceeds to step

In step S142, it is judged whether or not the fixed station 1 is a master AP (the details will be described later). When it is judged as the master AP (in the case of YES), the processing proceeds to step 108 that will be described later, and when it is judged that it is not the master AP (in other words, a slave AP) (in the case of NO), the processing proceeds to step S128 that will be described later.

Meanwhile, in step S102, following the actuation of the fixed station 1, in other words, booting, the booting information is given. Specifically, a predetermined packet for reporting that the fixed station 1 itself is actuated and starts the function as the fixed station is transmitted to the LAN trunk line 12 from the fixed station 1 in a broadcast. Here, as already explained in the precondition, since the fixed station 1 is actuated first, no other fixed stations receive this booting information, and thus, the booting information in this case does not have a real meaning.

Next, it is judged whether or not other fixed stations exist in the same segment, specifically, in other words, in the same subnet (post actuation fixed station existence judgement processing)(refer to step S104 in FIG. 3).

In concrete, a question packet is transmitted to the LAN trunk line 12 from the fixed station executing this processing, that is, the fixed station 1, here. When other fixed stations is connected to the LAN trunk line 12 in the same segment, and if they receive this question packet, the question packet requests a response packet from the fixed stations. The fixed station 1 judges the absence or presence of the other fixed stations according to the absence or presence of the response packet.

Since the explanation herein assumes the condition in which only the fixed station 1 is booted, it is judged that the other fixed stations do not exist (NO) in the judgment of step S104, and processing proceeds to step S106.

In step S106, following the judgement that the other fixed stations do not exist within the same segment from the judgment of the previous step S104, the fixed station 1 is made a master station (represented by “MASTER AP” in step S106 in FIG. 3) for convenience.

Next, it is judged whether or not the other fixed stations, that is, slave fixed stations (slave AP) are added into the same segment (refer to step S108 in FIG. 3). The slave fixed station means the fixed station actuated after the master fixed station 1 is fixed as described above, and in the embodiment of the present invention, both fixed stations 2 and 3 are made the slave fixed stations. The judgement whether or not the slave fixed station is added is made with the present or absence of the booting information from the slave fixed station. Note that it is assumed that the remaining fixed stations 2 and 3 are not actuated yet here.

Subsequently, in step S108, when it is judged that no slave fixed station is added yet (in the case of NO), processing proceeds to step S112 which will be described later without going through the process in step S110 which will be described next, and when it is judged that the slave fixed station is added (in the case of YES), processing proceeds to step S110 which will be described next.

In step S110, the MAC addresses of the mobile terminals 4 to 8 held by the master fixed station 1 are transmitted to the slave fixed station connected thereto at this point of time via the LAN trunk line 12. Now, it is assumed that the fixed stations 2 and 3 are not actuated yet, and therefore the execution of this step S110 does not have a real meaning.

Next, it is judged whether or not the static MAC address table of the master fixed station 1 is renewed (refer to step S112 in FIG. 3). The renewal of the static MAC address here is a well-known function which all of the fixed stations 1 to 3 have in common, and it means newly adding the MAC address of a new mobile terminal coming from another segment, other than the mobile terminals 4 to 8 previously stored as the mobile terminals which the fixed stations 1 to 3 communicate with, for example, the mobile terminal 9 shown by the dotted line in FIG. 1 to the static MAC address tables in predetermined storage areas of the storage sections 16 of the fixed stations 1 to 3.

The renewal of the static MAC address as described above can be usually made, for example, from the administrative computer 10, or an additional computer (not shown) is connected to the fixed stations 1 to 3, whereby the renewal can be made by this computer. Now, it is assumed that in the master fixed station 1, the renewal of the static MAC address as described above is not made here.

In step S112, when it is judged that the renewal of the static MAC address table of the master fixed station 1 is made (in the case of YES), processing proceeds to step S114 which will be described next, and when it is judged that the renewal of the static MAC address table is not made (in the case of NO), processing proceeds to step S118 (see FIG. 4) that will be described later without going through the process of step S114.

In step S114, MAC renewal information for the same segment is transmitted via the LAN trunk line 12 in order to inform the slave fixed stations that the static MAC address table is renewed in the master fixed station 1. If the other fixed stations 2 and 3 are actuated at this point of time, the MAC renewal information is received by the fixed stations 2 and 3, and is used in the fixed stations 2 and 3 to judge whether or not it is necessary to start receiving data of the static MAC address table transmitted from the master fixed station 1 in the process of the next step S116, as will described later (see step S128 that will be described later).

Next, in step S116 (see FIG. 4), the content (data) of the static MAC address table of the master fixed station 1 is transmitted to the slave fixed stations actuated at this point of time in the same segment. Accordingly, the MAC addresses of the mobile terminals 4 to 8 are registered in the static MAC address table of the master fixed station 1 as in the precondition previously stated, and thus the content thereof is the content of each of the static MAC address table of the slave fixed stations actuated at this point of time in the same segment.

Next, it is judged whether or not the static MAC address tables of the slave fixed stations in the same segment are renewed (see step S118 in FIG. 4).

That is, more specifically, the slave fixed stations in the same segment are actuated at this point of time, and when the renewal of the static MAC address table in the same sense as previously mentioned in the explanation of the processing of step S112 in the slave fixed station occurs, the MAC renewal information for the fixed stations in the same segment is transmitted via the LAN trunk line 12 as in the case of the master fixed station 1 previously mentioned, and in step S118, the presence or absence of the renewal of the static MAC address table in the slave fixed station is judged by judging the presence or absence of such information.

Subsequently, in step S 118, when it is judged that the renewal of the static MAC address tables in the slave fixed station exists (in the case of YES), processing proceeds to step S120 that will be described next, and in step S118, when it is judged that the renewal of the static MAC address tables in the slave fixed station does not exist (in the case of NO), a series of processing is finished to return to a main routine processing not shown for a time. A series of processing shown in FIG. 3 and FIG. 4 is repeated again via the main routine processing.

Now, if both the remaining fixed stations 2 and 3 are not actuated yet here, it is judged that the renewal of the static MAC address tables in the slave fixed stations does not exist in step S118, and a series of processing is finished to return to the main routine processing not shown for a time. The series of processing shown in FIG. 3 and FIG. 4 is repeated again via the main routine processing.

On the other hand, if any one of the fixed stations 2 and 3 is actuated at this point of time, and if renewal of the static MAC address table occurs therein, and when it is judged that the renewal of the static MAC address table in the slave fixed station exists, in step S118, (in the case of YES), in step S120, the master fixed station 1 receives the transmission of the content (data) of the static MAC address table from the corresponding slave fixed station, and its own static MAC address table is renewed. Specifically, suppose that the slave fixed station 2 is actuated at this point of time, and the static MAC address table is renewed. For example, if, in addition to the MAC addresses of the mobile terminals 4 to 8 previously registered in the static MAC address table of the slave fixed station 2, the MAC address of the new mobile terminal 9 is added, the content of the static MAC address table of the fixed station 2 after renewal is received by the master fixed station 1, and the static MAC address table of the master fixed station 1 is renewed. Accordingly, in this case, the MAC addresses of the mobile terminals 4 to 9 are registered in the static Mac address table in the master fixed station 1.

In step S122, the content of the renewed static MAC address table of the master fixed station 1 is transmitted to the slave fixed station other than the fixed slave station from which the transmission of the static MAC address table is received in the processing in step S120, and a series of processing of the MAC address management in the master fixed station 1 is finished to return to the main routine processing not shown for a time. The series of processing shown in FIG. 3 and FIG. 4 is repeated again via the main routine processing.

In the fixed station 1 being the master AP, in the series of processing from the second time on, by the judgement that this is not the first time in step S100 as explained above and the judgement that this is the master AP in step S142, steps S108 to S122 are repeatedly executed as actual the processing.

In the explanation of the processing so far, it is explained that the other fixed stations 2 and 3 are not actuated to facilitate understanding, but they may be actuated successively in an arbitrary timing if only it is after the fixed station 1 is made the master fixed station after the fixed station 1 is actuated (see step S106 in FIG. 3).

Next, suppose that the fixed station 2 is actuated after the series of processing through S122 is executed in the master fixed station 1, the processing in FIG. 3 and FIG. 4 in this case will be explained.

First, when the fixed station 2 is actuated, step S100 through step S104 are executed as explained with the master fixed station 1, but since the fixed station 1 is already actuated as the master fixed station in the judgement in step S104, it is judged that AP exists in the same segment, and processing proceeds to step S124, and the fixed station 2 is made the slave fixed station.

Next, data of the static MAC address table is transmitted from the master fixed station 1 which receives booting information (see step 102 in FIG. 3) of the fixed station 2, and the data is received, whereby the static MAC address table of its own station (fixed station 2) is renewed (see step S126 in FIG. 3). For example, at this point of time, suppose that the content of the static MAC address table has not renewed in the master fixed station 1 since the time of its actuation, the MAC addresses of the mobile terminals 4 to 8 are transmitted from the master fixed station 1. The content thereof is overwritten in the static MAC address table of the fixed station 2. In the embodiment of the present invention, since the fixed stations 1 to 3 belong to the same segment, it is assumed that the MAC addresses of the mobile terminals 4 to 8 are, so to speak, initialized in each of the static MAC address table thereof, and therefore under the condition that the static MAC address table of the fixed station 1 has not been renewed since the time of its actuation as described above, even if the overwriting in the static MAC address table as described above is performed in the fixed station 2, the content thereof does not actually change.

Next, it is judged whether or not the renewal of the static MAC address table exists in the master fixed station 1 (master fixed station MAC address table renewal presence or absence judgement processing) (see step S128 in FIG. 3). This is judged according to the presence or absence of the MAC renewal information as previously explained about the case of the master fixed station 1.

Subsequently, in step S128, when it is judged that renewal of the static MAC address table of the master fixed station 1 exists (in the case of YES), the processing proceeds to step S130 that will be described next, and when it is judged that the renewal of the static MAC address table in the master fixed station 1 does not exist (in the case of NO), the processing proceeds to step S132 that will be described later without going through step S130.

In step S130, on receiving the transmission of the data of the static MAC address table from the master fixed station 1, the static MAC address table of the fixed station 2 is renewed. Specifically, as described in the explanation of the processing in the previous step S126, the content of the static MAC address table of the master fixed station 1 is overwritten in the static MAC address table of the fixed station 2.

Next, in step S132, it is judged whether or not the renewal of the static MAC address table of this AP, that is, the fixed station 2 exists. Here, the renewal means to register a new mobile terminal to the fixed station 2, that is, to register a new MAC address as described in the explanation of the processing in the previous step S112.

Subsequently, in step S132, when it is judged that the static MAC address table of this AP is not renewed (in the case of NO), the processing proceeds to step S138 that will be described later.

On the other hand, in step S132, when it is judged that the renewal of the static MAC address table of the fixed station 2 exists (in the case of YES), the MAC renewal information as the information that the static MAC address table of the fixed station 2 is renewed is transmitted to the master fixed station 1 (see step S134 in FIG. 4).

Next, the MAC addresses registered in the static MAC address table of the fixed station 2 is transmitted (see step S136 in FIG. 4), and the processing in the next step S138 is performed.

In step S138, it is judged whether or not the content of the static MAC address table based on the processing in step S122 previously explained is transmitted from the master fixed station 1 (in other words, it is judged whether or not the transmission of the content of the static MAC address table of the master fixed station 1 after the renewal is received in the case in which the static MAC address table of the master fixed station 1 is renewed based on the renewal of the static MAC address table in the slave fixed station).

Subsequently, in step S138, when it is judged that the transmission of the content of the static MAC address table of the master fixed station 1 does not exist (in the case of NO), a series of processing is finished to return to the main routine processing not shown for a time. The series of processing shown in FIG. 3 and FIG. 4 is repeated again via the main routine processing.

On the other hand, in step S138, when it is judged that the transmission of the content of the static MAC address table of the master fixed station 1 exists (in the case of YES), the content of the static MAC address table transmitted from the master fixed station 1 is overwritten in the static MAC address table of the station itself (the slave fixed station 2), and a series of processing is finished to return to the main routine not shown for a time. The series of processing shown in FIG. 3 and FIG. 4 is repeated again via the main routine processing.

After the fixed station 2 finishes a series of processing as described above, the fixed station 3 is actuated, and the same processing as in the case of the aforementioned fixed station 2 is to be performed. The execution of each of the steps in FIG. 3 and FIG. 4 in this fixed station 3 is basically the same as in the case of the fixed station 2, and therefore the detailed explanation herein will be omitted.

The fixed station 3 may be actuated even before the fixed station 2 finishes the aforementioned series of processing, as long as it is after the fixed station 2 is actuated, and there is no change in that the series of necessary processing in FIG. 3 is executed as in the case of the fixed station 2.

As described above, the fixed stations 1 to 3 are actuated in the order, and the processing shown in FIG. 3 and FIG. 4 is executed, whereby each of the static MAC address tables becomes as will be described next.

First, in each of the fixed stations 1 to 3, when renewal of the static MAC address table does not exist after the actuation, in other words, when the registration of a new mobile terminal does not occur in addition to the mobile terminals 4 to 8 previously registered in the fixed stations 1 to 3, the content of the static MAC address table of the master fixed station 1 is overwritten in the fixed stations 2 and 3 as described above on their actuation, but their contents are originally the same as that of the master fixed station 1, and therefore the content of the static MAC address table does not actually change from the time of the actuation.

On the other hand, for example, if the new mobile terminal 9 is registered in the slave fixed station 2 after its actuation and the static MAC address table is renewed, in the slave fixed station 2 it is judged that the renewal of the static MAC address table of this AP, that is, the slave fixed station 2 exists in the processing in step S132, in this case. As a result, the transmission of the MAC renewal information and the transmission of the content of the static MAC address table after the renewal to the master fixed station 1 are performed (see steps S134 and S136 in FIG. 4).

In the master fixed station 1, corresponding to the aforementioned processing in the slave fixed station 2, it is judged that the renewal of the static MAC address table of the slave fixed station 2 exists, and the content of the static MAC address table transmitted from the slave fixed station 2 is overwritten in the static MAC address table of its station (the master fixed station 1) (see steps S118 and S120 in FIG. 4). Now, suppose that the fixed station 3 is already in an actuated state when the aforementioned renewal of the static MAC address table of the fixed station 2 is made, the master fixed station 1 transmits the content of the static MAC address table of its station after the renewal to the fixed station other than the slave fixed station 2, that is, the slave fixed station 3 (see step S122 in FIG. 4).

Subsequently, in the slave fixed station 3, it is judged that the transmission of the content of the static MAC address table from the master fixed station 1 exists based on the renewal of the static MAC address table in the slave fixed station 2, and the static MAC address table of its station (the slave fixed station 3) is renewed (see steps S138 and S140 in FIG. 4).

As a result, all the static MAC address tables of the master fixed station 1 and the slave fixed stations 2 and 3 become the same static MAC address tables having the MAC addresses of the mobile terminals 4 to 9. In other words, sharing of the static MAC addresses is achieved. In FIG. 2, the content of the static MAC address table which each of the fixed stations 1 to 3 finally obtains in the aforementioned case is schematically shown in the storage section 16 of each of the fixed stations 1 to 3.

Accordingly, suppose that the mobile terminal 9 moves into a service area range of the master fixed station 1 from a service area range of the fixed station 2, corresponding to which the mobile terminal 9 is recognized by roaming processing of the master fixed station 1, and an authentication request is made to the master fixed station 1 by the mobile terminal 9. In this case, since the static MAC address table contains the MAC address of the mobile terminal 9, the authentication request of the mobile terminal 9 to the master fixed station 1 is accepted, and packet exchange between the master fixed station 1 and the mobile terminal 9 becomes possible.

On the other hand, even if a mobile terminal belonging to a segment different from the segment to which the mobile terminals 4 to 8 belong moves into the service areas of the fixed stations 1 to 3, unless the MAC address of the new mobile terminal is registered in any of the fixed stations 1 to 3, an authentication request thereof is denied even if the new mobile terminal makes the authentication request to any of the fixed stations 1 to 3, since it is not registered in the static MAC address table which the fixed stations 1 to 3 have in common, and thus security maintenance is secured in the segment to which the fixed stations 1 to 3 belong.

In the above-described configuration example, the explanation is made on the precondition that the MAC address management program for the wireless LAN executed by the central control section 14 is stored in the nonvolatile semiconductor memory constituting part of the storage section 16 as a record medium for the program and the program is executed by being read by the central control section 14 from this semiconductor memory, but it goes without saying that the record medium is not limited to semiconductor memory.

That is, as the record medium, other than semiconductor memory, a flexible disc, CD-ROM, optical record medium such as a DVD and a PD, photomagnetic record medium such as an MD, magnetic record medium, and the like may be used. Depending on a record medium, devices for reading and writing data exclusive for the record medium are required, and it is natural that the storage section 16 may be constituted by including them.

As described thus far, according to the present invention, sharing of the static MAC address tables in a plurality of fixed stations connected in the same segment is achieved, and thus registration of the mobile terminal to the fixed station is made to only one of the fixed stations, whereby registration to the other fixed stations is also made, thus providing the effect of being able to construct the wireless LAN easy to use and extremely convenient, which makes it possible to communicate with all the fixed stations while securing security in the same segment, and makes the mobile terminals easily move inside the same subnet.

What is claimed is:

1. A MAC address management method of fixed stations in a wireless LAN system having the fixed stations connected to a LAN trunk line and mobile terminals for performing packet exchange with said fixed stations via a wireless line, comprising the steps of:
in the fixed stations actuated one by one in order
judging whether or not any other actuated fixed stations exist in a same segment after actuation, when it is judged that any other actuated fixed stations don't exist, making its own station a master fixed station, and when it is judged that the other actuated fixed station exists, making its own station a slave fixed station; and
in the master fixed station,
transmitting data of a static MAC address table of its own station to the slave fixed station when it is judged that the slave fixed station is newly actuated, and
when receiving transmission of data of the static MAC address table after renewal as a result of the renewal of the static MAC address table in the slave fixed station from the slave fixed station, renewing the static MAC address table of its own station according to the data of the static MAC address table of which transmission is received, and transmitting data of the static MAC address table of its own station after the renewal to the slave fixed stations other than the slave fixed station of which transmission of data of the static MAC address table is received to thereby allow sharing of MAC addresses.

2. The MAC address management method in the wireless LAN according to claim 1, further comprising the step of:
in the master fixed station, when renewal of the static MAC address table occurs as a result of registration of a new MAC address, transmitting data of the static MAC address table after the renewal to all the slave fixed stations.

3. The MAC address management method in the wireless LAN according to claim 2, further comprising the steps of:
in the slave fixed station, after actuation, receiving the data of the static MAC address table of the master fixed station from the master fixed station, and renewing the static MAC address table of its own station according to the transmitted data; and
when renewal of the static MAC address table occurs in the slave fixed station as a result of registration of a new MAC address, transmitting data of the static MAC address table after the renewal to the master fixed station.

4. The MAC address management method in the wireless LAN according to claim 3, further comprising the step of:
in the slave fixed station, when receiving transmission of data of the static MAC address table from the master fixed station other than the transmission of the data of the static MAC address table from the master fixed station just after the actuation, renewing the static MAC address table of its own station according to the transmitted data.

5. A MAC address management program for a wireless LAN for static MAC address management, which is executed by a central control section in a fixed station for a wireless LAN comprising a wired LAN control section for controlling packet exchange via a LAN trunk link, a wireless LAN control section for controlling packet exchange with a mobile terminal via a wireless line, a central control section for performing operation control of said wired LAN control section and said wireless LAN control section and performing static MAC address management, and a storage section for storing program necessary for operation of said wired LAN control section, wireless LAN control section and central control section and data, and having a packet relay function between a wired network and a wireless network,
wherein said central control section judges whether or not execution of the program is a first time, and when judging it is the first time, performs post actuation fixed station existence judging processing, while when judging it is not the first time, judges whether or not its own station is a master fixed station; and
in the judgement of whether or not it is the master fixed station, when judging its own station is the master fixed station, said central control section performs slave fixed station addition judgment processing, and when judging its own station is not the master fixed station, it performs master fixed station MAC address table renewal presence or absence judgment processing.

6. The MAC address management program for the wireless LAN according to claim 5, wherein the post actuation fixed station existence judgement processing is that immediately after the actuation of its own station, the central control section transmits a question packet requesting transmission of a response packet to a fixed station receiving it via the wired LAN control section, and judges whether or not any other actuated fixed stations exist in a same segment according to the presence or absence of reception of the response packet, and when judging that no other actuated fixed stations exist without receiving any response packet, the central control section makes its own station the master station, while when judging that the other actuated fixed station exists by receiving the response packet, it makes its own station the slave station.

7. The MAC address management program for the wireless LAN according to claim 6,
wherein when its own station becomes the master fixed station as a result of the post actuation fixed station existence judgement processing, the central control section performs the slave fixed station addition judgement processing,
wherein the slave fixed station addition judgement processing is that said central control section judges presence or absence of the fixed station in the same segment, which is actuated to be the slave fixed station after its own station becomes the master fixed station, according to presence or absence of the reception of booting information transmitted from the actuated fixed station, and
wherein when it is judged that the slave fixed station exists by said slave fixed station addition judgement processing, the central control section transmits data of its own static MAC address table stored in said storage section to the slave fixed station via said wired LAN control section.

8. The MAC address management program for the wireless LAN according to claim 7,
wherein as a result of the slave fixed station addition judgement processing, either after the time when it is judged that the slave fixed station does not exist, or after the time when data of the static MAC address table is transmitted to the slave fixed station based on the judgement result that the slave fixed station exists, the central control section judges whether or not renewal of its own static MAC address table occurs, and
wherein when it is judged that the renewal of its own static MAC address table occurs, the central control section transmits MAC renewal information reporting that the static MAC address table is renewed to the slave fixed stations in the same segment via the wired LAN control section, and transmits data of its own static MAC address table to the slave fixed stations in the same segment via said wired LAN control section.

9. The MAC address management program for the wireless LAN according to claim 8,
wherein in the judgement of the presence or absence of the renewal of its own static MAC address table, either after the time when it is judged that the renewal does not exist, or after the time when data after the renewal of its own static MAC address table is transmitted to the slave fixed stations, the central control section judges whether or not renewal of the static MAC address tables in the slave fixed stations occurs according to the presence or absence of the reception of MAC renewal information from the slave fixed stations,
wherein in the judgement of the presence or absence of the renewal of the static MAC address tables in said slave fixed station, when it is judged that the renewal of the static MAC address table in the slave fixed station exists, the central control section receives transmission of data of the static MAC address table from the slave fixed station and renews the data of its own static MAC address table, and after the renewal, it transmits the data of its own static MAC address table via said wired LAN control section to the slave fixed station other than the slave fixed station of which data transmission of the static MAC address table it receives, and
wherein in the judgement of the presence or absence of the renewal of the static MAC address table in said slave fixed stations, either after the time when it is judged that the renewal of the static MAC address tables in the slave fixed stations does not exist, or after the time when the data of the static MAC address table is transmitted to the other slave fixed station, the central control section repeats a series of processing again.

10. The MAC address management program for the wireless LAN according to claim 9,
wherein when its own station becomes the slave fixed station as a result of the post actuation fixed station existence judgement processing, the central control section receives transmission of the data of the static MAC address table from the master fixed station and renews the data of its own static MAC address table, and subsequently, performs the master fixed station MAC address table renewal presence or absence judgement processing,
wherein the master fixed station MAC address table renewal presence or absence judgement processing is to judge the presence or absence of the renewal of the static MAC address table in the master fixed station with the presence or absence of the reception of MAC renewal information from the master fixed station, and
wherein when it is judged that the renewal of the static MAC address table in the master fixed station exists as a result of the master fixed station MAC address table renewal presence or absence judgement processing, the central control section receives transmission of data of the static MAC address table from the master fixed station and renews the data of its own static MAC address table.

11. The MAC address management program for the wireless LAN according to claim 10,
wherein as a result of the master fixed station MAC address table renewal presence or absence judgement processing, either after the time when it is judged that the renewal of the static MAC address table in the master fixed station does not exist, or after the time when the data of its own static MAC address table is renewed on receiving transmission of the data of the static MAC address table from said master fixed station, the central control section judges whether or not renewal of its own static MAC address table occurs, and in the judgement, when it is judged that the renewal of its own static MAC address table occurs, it transmits MAC renewal information reporting that its own static MAC address table is renewed to the master fixed station via the wired LAN control section, and transmits data of its own static MAC address table to the master fixed station via said wired LAN control section.

12. The MAC address management program for the wireless LAN according to claim 11,
wherein in the judgement of presence or absence of the renewal of its own static MAC address table, either after the time when it is judged that the renewal does not exist, or after the time when data of its own static MAC address table is transmitted to the master fixed station, the central control section judges presence or absence of transmission of data of the static MAC address table from the master fixed station, and in the judgement, when it is judged that data transmission of the static MAC address table from the master fixed station exists, it renews the data of its own static MAC address table according to the transmitted data of the static MAC address table, and
wherein in the judgement of the presence or absence of transmission of the data of the static MAC address table from said master fixed station, either after the time when it is judged that transmission of the data does not exist, or after the time when renewal of its own static MAC address table is made on receiving transmission of the data of the static MAC address table from said master fixed station, the central control section repeats a series of processing again.

13. A computer-readable record medium recording a MAC address management program for a wireless LAN, which is executed by a central control section in a fixed station for a wireless LAN, comprising a wired LAN control section for controlling packet exchange via a LAN trunk link, a wireless LAN control section for controlling packet exchange with a mobile terminal via a wireless line, the central control section for performing operation control of said wired LAN control section and said wireless LAN control section and performing static MAC address management, and a storage section for storing program necessary for operation of said wired LAN control section, wireless LAN control section and central control section, and data, and having a packet relay function between a wired network and a wireless network,
wherein said central control section judges whether or not execution of the program is a first time, when judging it is the first time, performs post actuation fixed station existence judgement processing, and when judging it is not the first time, judges whether or not its own station is a master fixed station; and
in the judgement of whether or not it is the master fixed station, when judging its own station is the master fixed station, said central control section performs slave fixed station addition judgment processing, and when judging its own station is not the master fixed station, it performs master fixed station MAC address table renewal presence or absence judgment processing.

14. The computer-readable record medium recording the MAC address management program for the wireless LAN according to claim 13, wherein the post actuation fixed station existence judgement processing is that immediately after actuation of its own station, the central control section transmits a question packet requesting transmission of a response packet to the fixed station receiving it via the wired LAN control section, and judges whether or not any other actuated fixed stations exist in a same segment according to the presence or absence of reception of the response packet, and when judging that no other actuated fixed stations exist without receiving any response packet, the central control section makes its own station the master station, while when judging that the other actuated fixed station exists by receiving the response packet, it makes its own station the slave station.

15. The computer-readable record medium recording the MAC address management program for the wireless LAN according to claim 14,
wherein when its own station becomes the master fixed station as a result of the post actuation fixed station existence judgement processing, the central control section performs the slave fixed station addition judgement processing,
wherein the slave fixed station addition judgement processing is that said central control section judges presence or absence of the fixed station in the same segment, which is actuated to be the slave fixed station after its own station becomes the master fixed station, according to presence or absence of the reception of booting information transmitted from the actuated fixed station, and
wherein when it is judged that the slave fixed station exists as a result of the slave fixed station addition judgement processing, the central control section transmits data of its own static MAC address table stored in said storage section to the slave fixed station via said wired LAN control section.

16. The computer-readable record medium recording the MAC address management program for the wireless LAN according to claim 15,
wherein as a result of the slave fixed station addition judgement processing, either after the time when it is judged that the slave fixed station does not exist, or after the time when data of the static MAC address table is transmitted to the slave fixed station based on the judgement result that the slave fixed station exists, the central control section judges whether or not renewal of its own static MAC address table occurs, and
wherein when it is judged that the renewal of its own static MAC address table occurs, the central control section transmits MAC renewal information reporting that the static MAC address table is renewed to the slave fixed stations in the same segment via the wired LAN control section, and transmits data of its own static MAC address table to the slave fixed stations in the same segment via said wired LAN control section.

17. The computer-readable record medium recording the MAC address management program for the wireless LAN according to claim 16,
wherein in the judgement of presence or absence of the renewal of its own static MAC address table, either after the time when it is judged that the renewal does not exist, or after the time when data after the renewal of its own static MAC address table is transmitted to the slave fixed stations, the central control section judges whether or not renewal of the static MAC address tables in the slave fixed stations occurs according to the presence or absence of the reception of MAC renewal information from the slave fixed stations,
wherein in the judgement of the presence or absence of the renewal of the static MAC address tables in said slave fixed stations, when it is judged that the renewal of the static MAC address table in the slave fixed station exists, the central control section receives transmission of data of the static MAC address table from the slave fixed station and renews the data of its own static MAC address table, and after the renewal, it transmits the data of its own static MAC address table via said wired LAN control section to the slave fixed station other than the slave fixed station of which data transmission of the static MAC address table it receives, and
wherein in the judgement of the presence or absence of the renewal of the static MAC address table in said slave fixed stations, either after the time when it is judged that the renewal of the static MAC address tables in the slave fixed stations does not exist, or after the time when the data of the static MAC address table is transmitted to the other slave fixed station, the central control section repeats a series of processing again.

18. The computer-readable record medium recording the MAC address management program for the wireless LAN according to claim 17,
wherein when its own station becomes the slave fixed station as a result of the post actuation fixed station existence judgement processing, the central control section receives transmission of the data of the static MAC address table from the master fixed station and renews the data of its own static MAC address table, and subsequently, performs the master fixed station MAC address table renewal presence or absence judgement processing,
wherein the master fixed station MAC address table renewal presence or absence judgement processing is to judge the presence or absence of the renewal of the static MAC address table in the master fixed station with the presence or absence of the reception of MAC renewal information from the master fixed station, and
wherein when it is judged that the renewal of the static MAC address table in the master fixed station exists as a result of the master fixed station MAC address table renewal presence or absence judgement processing, the central control section receives transmission of data of the static MAC address table from the master fixed station and renews the data of its static MAC address table.

19. The computer-readable record medium recording the MAC address management program for the wireless LAN according to claim 18,
wherein as a result of the master fixed station MAC address table renewal presence or absence judgement processing, either after the time when it is judged that the renewal of the static MAC address table in the master fixed station does not exist, or after the time when the data of its own static MAC address table is renewed on receiving data transmission of the static MAC address table from said master fixed station, the central control section judges whether or not renewal of its own static MAC address table occurs, and in the judgement, when it is judged that the renewal of its own static MAC address table occurs, it transmits MAC renewal information reporting that its own static MAC address table is renewed to the master fixed station via the wired LAN control section, and transmits data of its own static MAC address table to the master fixed station via said wired LAN control section.

20. The computer-readable record medium recording the MAC address management program for the wireless LAN according to claim 19,
wherein in the judgement of the presence or absence of the renewal of its own static MAC address table, either after the time when it is judged that the renewal does not exist, or after the time when data of its own static MAC address table is transmitted to the master fixed station, the central control section judges presence or absence of transmission of data of the static MAC address table from the master fixed station, and in the judgement, when it is judged that transmission of the data of the static MAC address table from the master fixed station exists, it renews the data of its own static MAC address table according to the transmitted data of the static MAC address table, and
wherein in the judgement of the presence or absence of the transmission of the data of the static MAC address table from said master fixed station, either after the time when it is judged that transmission of the data does not exist, or after the time when renewal of its own static MAC address table is made on receiving transmission of the data of the static MAC address table from said master fixed station, the central control section repeats a series of processing again.

21. A fixed station for a wireless LAN, comprising:
a wired LAN control section for controlling packet exchange via a LAN trunk link;
a wireless LAN control section for controlling packet exchange with mobile terminals via a wireless line;
a central control section for performing operation control of said wired LAN control section and said wireless LAN control section, and performing static MAC address management; and
a storage section for storing program necessary for operation of said wired LAN control section, wireless LAN control section and central control section, and data,
said fixed station having a packet relay function between a wired network and a wireless network,
wherein said central control section judges whether or not any other actuated fixed stations exist in a same segment after actuation, and when it is judged that any other actuated fixed stations don't exist, it makes its own station a master fixed station, while when it is judged that the other actuated fixed station exists, it makes its own station a slave fixed station,
wherein in the master fixed station, said central control section transmits data of a static MAC address table of its own station to the slave fixed station when it is judged that the slave fixed station is newly actuated, and when receiving transmission of data of the static MAC address table after renewal as a result of the renewal of the static MAC address table in the slave fixed station from the slave fixed station, it renews the static MAC address table of its own station according to the data of the static MAC address table of which transmission it receives, and transmits data of the static MAC address table of its own station after the renewal to the slave fixed station other than the slave fixed station of which transmission of data of the static MAC address table it receives.

22. The fixed station for the wireless LAN according to claim 21,
wherein in the master fixed station, when renewal of the static MAC address table occurs as a result of registration of a new MAC address, said central control section transmits data of the static MAC address table after the renewal to all the slave fixed stations.

23. The fixed station for the wireless LAN according to claim 22,
wherein in the slave fixed station, after actuation, said central control section receives transmission of data of the static MAC address table of the master fixed station from the master fixed station, and renews the static MAC address table of its own station according to the transmitted data; and
when renewal of the static MAC address table occurs in the slave fixed station as a result of registration of a new MAC address, it transmits data of the static MAC address table after the renewal to the master fixed station.

24. The fixed station for the wireless LAN according to claim 23,
wherein in the slave fixed station, when receiving transmission of data of the static MAC address table from the master fixed station other than the transmission of the data of the static MAC address table from the master fixed station after the actuation, said central control section renews the static MAC address table of its own station according to the transmitted data.

25. A fixed station for a wireless LAN, comprising:
a wired LAN control section for controlling packet exchange via a LAN trunk link,
a wireless LAN control section for controlling packet exchange with mobile terminals via a wireless line;
a central control section for performing operation control of said wired LAN control section and said wireless LAN control section and performing static MAC address management; and
a storage section for storing program necessary for operation of said wired LAN control section, wireless LAN control section and central control section, and data,
said fixed station having a packet relay function between a wired network and a wireless network,
wherein the static MAC address management by said central control section is performed by execution of a MAC address management program for a wireless LAN by said central control section, and the MAC address management program for the wireless LAN is structured so that
said central control section judges whether or not execution of the program is a first time, and when judging it is the first time, performs post actuation fixed station existence judgement processing, while when judging it is not the first time, judges whether or not its own station is a master fixed station, and
in the judgement of whether or not it is the master fixed station, when judging its own station is the master fixed station, said central control section performs slave fixed station addition judgment processing, and when judging its own station is not the master fixed station, it performs master fixed station MAC address table renewal presence or absence judgment processing.

26. The fixed station for the wireless LAN according to claim 25, wherein the post actuation fixed station existence judgement processing is that immediately after actuation of its own station, the central control section transmits a question packet requesting transmission of a response packet to the fixed stations that receives it via the wired LAN control section, and judges whether or not any other actuated fixed stations exist in a same segment according to the presence or absence of reception of the response packet, and when judging that no other actuated fixed stations exist without receiving any response packet, the central control section makes its own station the master station, while when judging that the other actuated fixed station exists by receiving the response packet, it makes its own station the slave station.

27. The fixed station for the wireless LAN according to claim 26,
wherein when its own station becomes the master fixed station as a result of the post actuation fixed station existence judgement processing, the central control section performs the slave fixed station addition judgement processing,
wherein the slave fixed station addition judgement processing is that said central control section judges presence or absence of the fixed station in the same segment, which is actuated to be the slave fixed station after its own station becomes the master fixed station with presence or absence of the reception of booting information transmitted from the actuated fixed station, and
wherein when it is judged that the slave fixed station exists as a result of said slave fixed station addition judgement processing, the central control section transmits data of its own static MAC address table stored in said storage section to the slave fixed station via said wired LAN control section.

28. The fixed station for the wireless LAN according to claim 27,
wherein as a result of the slave fixed station addition judgement processing, either after the time when it is judged that the slave fixed station does not exist, or after the time when data of the static MAC address table is transmitted to the slave fixed station based on the judgement result that the slave fixed station exists, the central control section judges whether or not renewal of its own static MAC address table occurs, and
wherein when it is judged that the renewal of its own static MAC address table occurs, the central control section transmits MAC renewal information reporting that the static MAC address table is renewed to the slave fixed stations in the same segment via the wired LAN control section, and transmits data of its own static MAC address table to the slave fixed stations in the same segment via said wired LAN control section.

29. The fixed station for the wireless LAN according to claim 28,
wherein in the judgement of presence or absence of the renewal of its own static MAC address table, either after the time when it is judged that the renewal does not exist, or after the time when data after the renewal of its own static MAC address table is transmitted to the slave fixed stations, the central control section judges whether or not renewal of the static MAC address tables in the slave fixed stations occurs according to presence or absence of the reception of MAC renewal information from the slave fixed stations,
wherein in the judgement of presence or absence of the renewal of the static MAC address tables in said slave fixed stations, when it is judged that the renewal of the static MAC address table in the slave fixed station exists, the central control section receives transmission of data of the static MAC address table from the slave fixed station and renews the data of its own static MAC address table, and after the renewal, it transmits the data of its own static MAC address table via said wired LAN control section to the slave fixed station other than the slave fixed station from which data transmission of the static MAC address table it receives, and
wherein in the judgement of the presence or absence of the renewal of the static MAC address table in said slave fixed stations, either after the time when it is judged that the renewal of the static MAC address tables in the slave fixed stations does not exist, or after the time when the data of the static MAC address table is transmitted to the other slave fixed station, the central control section repeats a series of processing again.

30. The fixed station for the wireless LAN according to claim 29,
wherein when its own station becomes the slave fixed station as a result of the post actuation fixed station existence judgement processing, the central control section receives transmission of the data of the static MAC address table from the master fixed station and renews the data of its own static MAC address table, and subsequently, performs the master fixed station MAC address table renewal presence or absence judgement processing,
wherein the master fixed station MAC address table renewal presence or absence judgement processing is to judge the presence or absence of the renewal of the static MAC address table in the master fixed station with the presence or absence of the reception of MAC renewal information from the master fixed station, and
wherein when it is judged that the renewal of the static MAC address table in the master fixed station exists as a result of said master fixed station MAC address table renewal presence or absence judgement processing, the central control section receives transmission of data of the static MAC address table from the master fixed station and renews the data of its own static MAC address table.

31. The fixed station for the wireless LAN according to claim 30,
wherein as a result of the master fixed station MAC address table renewal presence or absence judgement processing, either after the time when it is judged that the renewal of the static MAC address table in the master fixed station does not exist, or after the time when the data of its own static MAC address table is renewed on receiving transmission of the data of the static MAC address table from said master fixed station, the central control section judges whether or not renewal of its own static MAC address table occurs, and in the judgement, when it is judged that the renewal of its own static MAC address table occurs, it transmits MAC renewal information reporting that its own static MAC address table is renewed to the master fixed station via the wired LAN control section, and transmits data of its own static MAC address table to the master fixed station via said wired LAN control section.

32. The fixed station for the wireless LAN according to claim 31,
wherein in the judgement of the presence or absence of the renewal of its own static MAC address table, either after the time when it is judged that the renewal does not exist, or after the time when data of its own static MAC address table is transmitted to the master fixed station, the central control section judges presence or absence of transmission of data of the static MAC address table from the master fixed station, and in the judgement, when it is judged that transmission of the data of the static MAC address table from the master fixed station exists, it renews the data of its own static MAC address table according to the transmitted data of the static MAC address table, and
wherein in the judgement of presence or absence of the transmission of the data of the static MAC address table from said master fixed station, either after the time when it is judged that transmission of the data does not exist, or after the time when renewal of its own static MAC address table is made on receiving transmission of the data of the static MAC address table from said master fixed station, the central control section repeats a series of processing again.

33. A wireless LAN system with a plurality of fixed stations having a packet relay function between a wired network and a wireless network being connected to a LAN trunk line, having a plurality of mobile terminals previously registered to said plurality of fixed stations and allowed to exchange packets with the fixed stations via a wireless line,
wherein said fixed station is the fixed station for the wireless LAN according to any one of claim 21 through claim 32.
